(19) United States
(12) Patent Application Publication
(10) Pub. No.: US 2023/0116110 A1
(43) Pub. Date: Apr. 13, 2023

(54) Methods, Systems and Computer Program Products for Selective Routing of Software Instructions Between a Client Device and a Cloud Services Server

(71) Applicant: Bluestack Systems, Inc., Campbell, CA (US)

(72) Inventor: Suman Saraf, Gurgaon (IN)

(21) Appl. No.: 17/962,449

(22) Filed: Oct. 7, 2022

Related U.S. Application Data
(60) Provisional application No. 63/253,888, filed on Oct. 8, 2021.

(51) Int. Cl. G06F 8/65; H04L 67/00

(52) U.S. Cl. CPC G06F 8/65; H04L 67/34

(57) ABSTRACT

Methods, systems and computer program products for cloud based software program execution include the steps of: receiving a data message identifying a software code instruction for execution, wherein said software code instruction is associated with functionality of an instance of a cloud based software application. One of a client terminal and a server is selected for execution of the software code instruction, and the software code instruction is routed to the selected client terminal or server. Selection of the client terminal or the server is based on routing rules and any one or more of information representing capabilities of the client terminal or of the server, information identifying a storage location of the software code instruction, and information representing hardware configurations or hardware systems required or preferred for execution of the software code instruction.

### CROSS-REFERENCE TO RELATED APPLICATION

This application claims priority to U.S. Provisional Patent Application No. 63/253,888 filed Oct. 8, 2021, the disclosure of which is hereby incorporated by reference in its entirety.

### BACKGROUND OF THE INVENTION

### Field of the Invention

The present invention relates to the domain of cloud based software services. In particular, the present invention provides methods, systems and computer program products for selective routing of requests/instructions for implementing software code instructions between a client device and a cloud services server, and in an embodiment in connection with for cloud based execution of gaming software.

### Description of Related Art

With the increase in availability of affordable computing hardware, it has become commonplace for individuals to use computing devices or data processing devices for accessing cloud based, or network based, services.

In a typical cloud based software services environment, one or more client terminals may interface through a network (such as the Internet), with a server (or with any other computing device located within the cloud), which is configured to provide cloud based service(s) to a requesting client terminal. In providing the cloud based software service(s), a software application required by a requesting client terminal is installed and run on the server, and video and audio output data from the software application is streamed to and rendered on the requesting client terminal. The inputs received from a user or operator of the requesting client terminal are in turn transmitted back to the server and are used to control execution of the software application that is running on the server.

There are however circumstances where it may be non-optimal or otherwise undesirable to execute certain software instructions relating to the software application, or to store certain types of data relating to the user or software application in the cloud. Examples include where execution of certain types of software instructions on the cloud result in undesirable latency at the client terminal, or where execution of such software instructions may result in exposure of confidential user data to the risk of misappropriation through the cloud. There is accordingly a need for solutions that address these and similar problems,

### SUMMARY OF THE INVENTION

The present invention provides methods, systems and computer program products for selective routing of software instructions between a client device and a cloud services server, and in an embodiment in connection with for cloud based execution of gaming software.

In an embodiment of the invention more generally described above, the invention comprises a method for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network. The method comprises the steps of (i) initiating network communication between the client terminal and the server, for delivery of streaming data that is output from the instance of the cloud based software application, from the server to the client terminal, (ii) initiating execution of the instance of the cloud based software application at the server, (iii) receiving a data message identifying a software code instruction for execution, wherein said software code instruction is associated with functionality of the instance of the cloud based software application, (iv) selecting one of the client terminal and the server for execution of the software code instruction, wherein the step of selecting one of the client terminal and the server is based on (a) one or more rules for routing software code instructions to one or the other of the client terminal and the server for execution, and (b) any one or more of information representing capabilities of the client terminal, information representing capabilities of the server, information identifying a storage location of the software code instruction, and information representing hardware configurations or hardware systems required or preferred for execution of the software code instruction, and (v) routing the software code instruction to the selected client terminal or selected server.

The invention also provides a system for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network. The system comprises at least one processor, and a non-transitory memory.

The processor is configured to implement the steps of (i) initiating network communication between the client terminal and the server, for delivery of streaming data that is output from the instance of the cloud based software application, from the server to the client terminal, (ii) initiating execution of the instance of the cloud based software application a the server, (iii) receiving a data message identifying a software code instruction for execution, wherein said software code instruction is associated with functionality of the instance of the cloud based software application, (iv) selecting one of the client terminal and the server for execution of the software code instruction, wherein the step of selecting one of the client terminal and the server is based on (a) one or more rules for routing software code instructions to one or the other of the client terminal and the server for execution, and (b) any one or more of information representing capabilities of the client terminal, information representing capabilities of the server, information identifying a storage location of the software code instruction, and information representing hardware configurations or hardware systems required or preferred for execution of the software code instruction, and (v) routing the software code instruction to the selected client terminal or selected server.

The invention also provides a computer program product for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network. The computer program product comprises a non-transitory computer readable medium having a computer readable program code embodied therein, the computer readable program code comprising instructions for implementing the steps of (i) initiating network communication between the client terminal and the server, for delivery of streaming data that is output from the instance of the cloud based software application, from the server to the client terminal, (ii) initiating execution of the instance of the cloud based software application at the server, (ill) receiving a data message identifying a software code instruction for execution, wherein said software code instruction is associated with functionality of the instance of the cloud based software application, (iv) selecting one of the client terminal and the server for execution of the software code instruction, wherein the step of selecting one of the client terminal and the server is based on (a) one or more rules for routing software code instructions to one or the other of the client terminal and the server for execution, and (b) any one or more of information representing capabilities of the client terminal, information representing capabilities of the server, information identifying a storage location of the software code instruction, and information representing hardware configurations or hardware systems required or preferred for execution of the software code instruction, and (v) routing the software code instruction to the selected client terminal or selected server.

### BRIEF DESCRIPTION OF THE DRAWINGS

FIGS. 1 and 2 illustrate system environments of a kind that may be used to implement the teachings of the present invention.

FIG. 3 illustrates an embodiment of a cloud services server configured in accordance with the teachings of the present invention.

FIG. 4 illustrates an embodiment of a client terminal configured in accordance with the teachings of the present invention.

FIG. 5 is a flowchart illustrating a method of selectively routing requests/instructions for execution of software code instructions to either one of a client terminal or a cloud services server, in accordance with the teachings of the present invention.

FIG. 6 illustrates an exemplary system for implementing the present invention.

### DESCRIPTION OF THE INVENTION

The invention provides methods, systems and computer program products for selective routing of software instructions between a client device and a cloud services server, and in an embodiment in connection with for cloud based execution of gaming software.

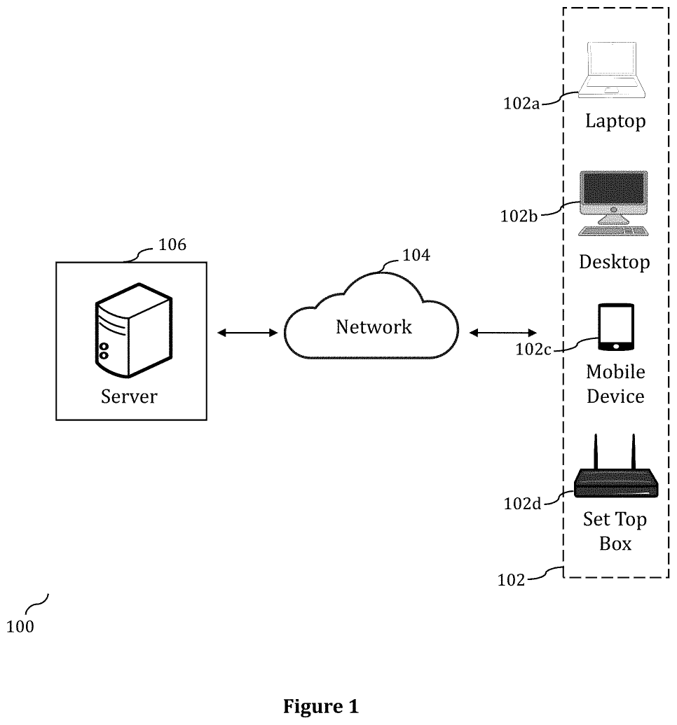

FIG. 1 illustrates a system environment 100 of a kind that may be used for implementing cloud based, or network based, services in accordance with the teachings of the present invention. System environment 100 comprises one or more client terminals 102 (for example, any of laptop 102a, desktop 102b, mobile device 102c and/or set top box 102d) interfacing through network 104, with a server 106 (which server may comprise any cloud based computing device). The client terminal 102 may interface with the server 106 through user interface software installed on the client terminal 102, which provides a user interface for an operator of the client terminal 102. Server 106 may be configured to provide cloud based service(s) to a requesting client terminal 102, wherein a software application required by client terminal 102 is installed and run on server 106, and video and audio output data from the software application is streamed to and rendered on client terminal 102. The inputs received from a user or operator of the client terminal 102 are in turn transmitted back to server 106 and are used to control execution of the software application that is running on the server 106.

So for example, in a cloud based gaming environment, a game application software is installed and run on a cloud based computing device configured to run the game software—and which is integrated or coupled with server 106. The game application software is run on the computing device and video and audio gameplay data is streamed from the computing device (optionally through server 106) to a client terminal 102, where it is rendered for display and/or audio playback. A gameplayer who is operating client terminal 102 uses the interface controls of user interface software installed on client terminal 102 to provide gameplay inputs which are streamed back to the computing device on which the game software is being executed and is used as gameplay control inputs for the game software that is being run on said computing device. As a result, gameplayers from any location can play a video game or a computer game without having to secure specialized video game consoles, software or graphics processing hardware—and relying instead on securing on-demand execution of the game application software by a cloud based server or cloud based computing device.

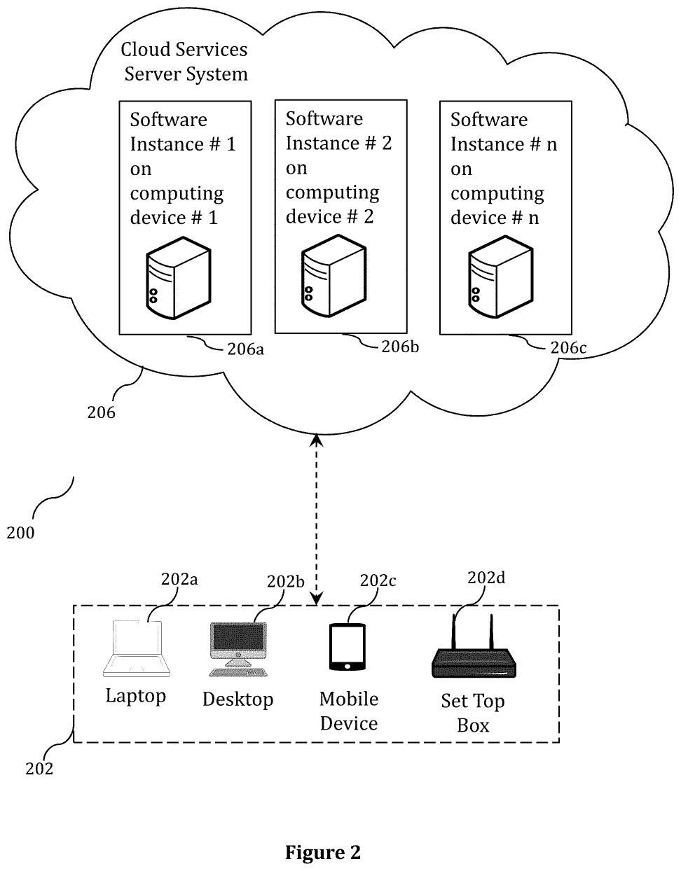

FIG. 2 illustrates system environment 200—which comprises one or more client terminals 202 (for example, any of laptop 202a, desktop 202b, mobile device 202c and/or set top box 202d) interfacing through a communication network such as a data network or the internee (not shown), with a cloud services server system 206. The cloud services server system 206 may comprise (or may be coupled with) a plurality of discrete or distinct computing systems (computing device #1, computing device #2 upto computing device #n)—each of which may be configured to be provisioned with, and to instantiate and run a discrete instance of one or more software applications. As a result, cloud services server system 206 may utilize the plurality of discrete or distinct computing systems to simultaneously run software instance #1 (206a), software instance #2 (206b), upto software instance #n (206c)—such that video and/or audio data from each of these software instances 206a to 206c may be streamed to one or more requesting client terminals 202a to 202d.

By way of an example:

client terminal 202a may request cloud services server system 206 for cloud based execution of a first software application and cloud services server system 206 may respond by (i) instantiating an instance of this first software application (software instance #1) to run on a first computing device (hardware device #1), and (ii) streaming video and/or audio data from the instance of the first software application to client terminal 202a.

client terminal 202b may request cloud services server system 206 for cloud based execution of a second software application (which may be the same as the first software application, or may comprise a different software application)—and cloud services server system 206 may respond by (i) instantiating an instance of this second software application (software instance #2) to run on a second computing device (computing device #2), and (ii) streaming video and/or audio data from the instance of the second software application to client terminal 202b client terminal 202c may request cloud services server system 206 for cloud based execution of an nth software application (which may be the same as either of the first or second software applications, or may be different from both)—and cloud services server system 206 may respond by (i) instantiating an instance of this n^{th} software application (software instance #n) to run on a n^{th} computing device (computing device #n), and (ii) streaming video and/or audio data from the instance of the nth software application to client terminal 202c.

The present invention recognizes that there may be circumstances where it may be non-optimal or otherwise undesirable to execute certain software instructions relating to the software application, or to store certain types of data relating to the user or software application in the cloud. Examples include where execution of certain types of software instructions on the cloud result in undesirable latency at the client terminal, or where execution of such software instructions may result in exposure of confidential user data to the risk of misappropriation through the cloud. There is accordingly a need for solutions that address these and similar problems.

The invention addresses this problem by selectively executing certain functionality of the software using the hardware of the client terminal, while simultaneously executing other functionality of the software using the hardware of a cloud services server. In other words, the hardware of the client terminal is used for execution of software program instructions that are associated with (or that are part of) the software application and which are of a first type or which have a first set of attributes. The hardware of a cloud services server is used for execution of software program instructions associated with (or that are part of) the software application and which are of a second type or which have a second set of attributes. It will be understood that selection of the client terminal or the cloud services server for execution of specific software program instructions may be determined based on any number of different factors—including for example data security concerns, latency concerns, network communication speed concerns etc.

Any output from execution of software instructions by either the client terminal or the cloud services server may be routed to a user interface application that is being implemented on the client terminal—for presentation of the output to a user or operator of the client terminal.

It would be understood that implementation of the invention requires the client terminal to be configured to implement a first set of software code instructions, and the cloud services server to be configured to implement a second set of software code instructions that is distinct from (i.e. different from) the first set of software code instructions, and for a request for execution of software code instructions to be routed for execution to the processor of the client terminal or to the cloud services server depending on whether the software code instructions identified within the request are part of the first set of software code instructions or the second set of software code instructions.

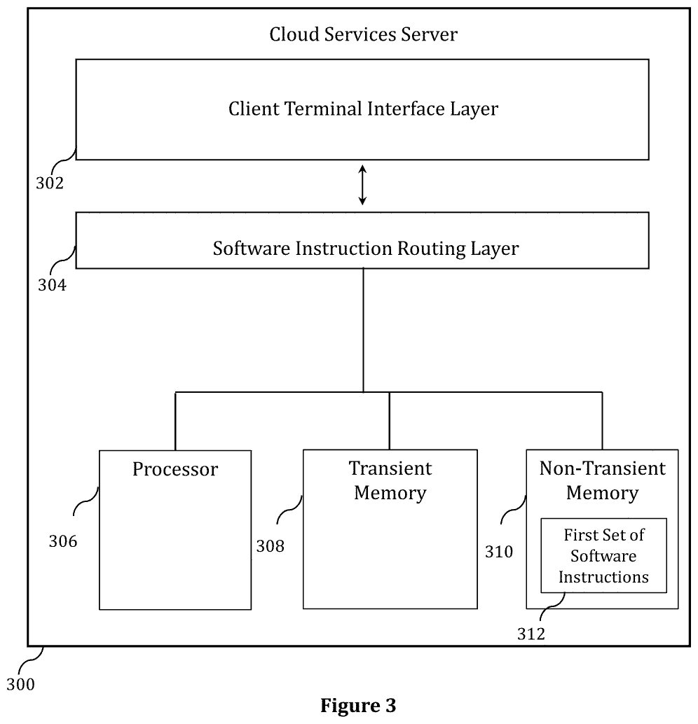

FIG. 3 illustrates an embodiment of a cloud services server 300 configured in accordance with the teachings of the present invention. Cloud services server system comprises a client terminal interface layer 302 comprising a processor implemented network communication interface layer that enables the cloud services server 300 to communicate with one or more client terminals for the purposes of providing cloud services to such client terminal(s). Any and all data communications between computing devices within the cloud services server system 300 and one or more client terminals for the purposes of providing cloud services to said client terminals is routed through client device interface layer 302.

In the illustrated embodiment, cloud services server 300 comprises a processor 306, a transient memory 308 and a non-transient memory 310. Non-transient memory 310 comprises memory storage that includes a stored first set of software code instructions 312.

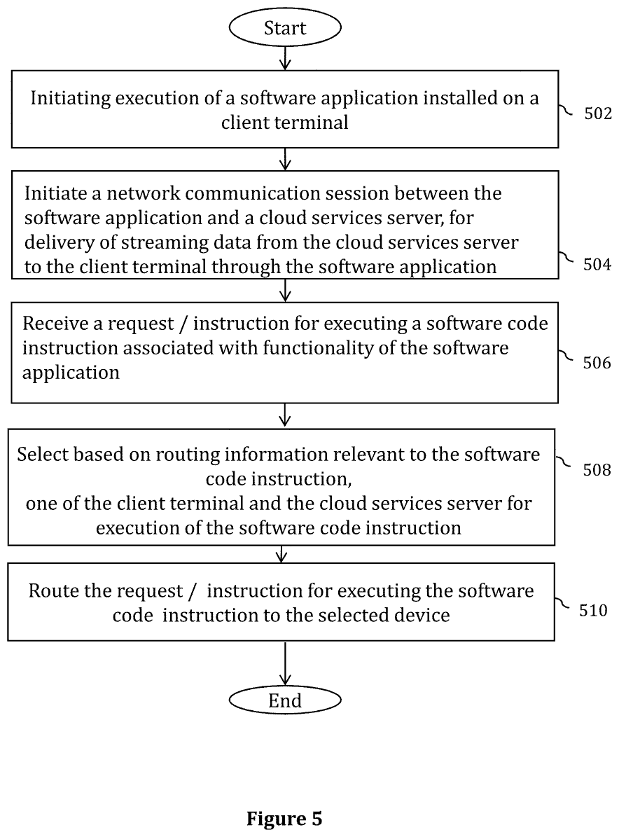

Cloud services server system 300 may optionally includes a processor implemented software instruction routing layer 304 configured to implement one or more of the steps of the method of FIG. 5 that are discussed in more detail subsequently, including the steps of (i) receiving for execution, a request for implementing a software code instruction corresponding to an instance of a software application that is under execution within the cloud services server 300, (ii) analyzing the request for implementing the software code instruction, and determining whether the software code instruction is stored on or executable at the cloud services server 300 or at a client terminal, (iii) routing the request for implementing the software code instruction to one of the client terminal or the processor 306 within cloud services server 300, for execution.

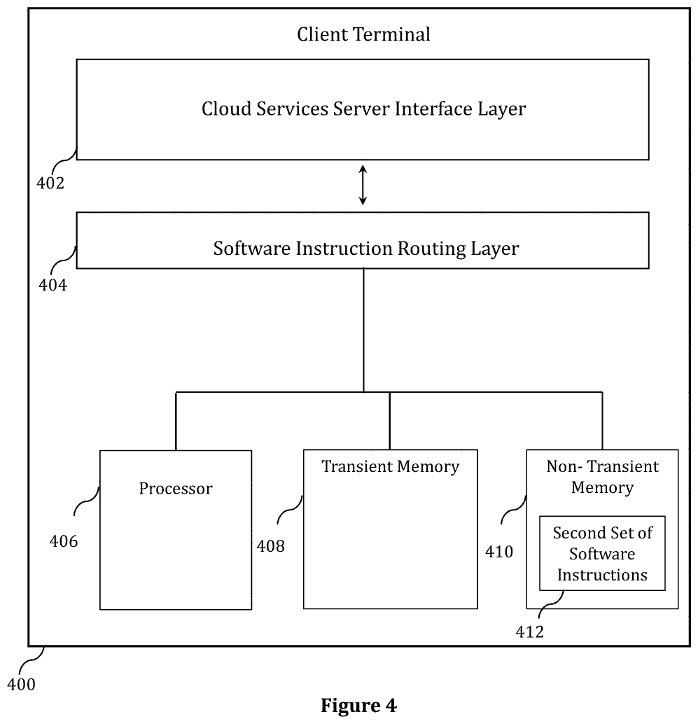

FIG. 4 illustrates an embodiment of a client terminal 400 configured in accordance with the teachings of the present invention. Client terminal 400 comprises a cloud services server interface layer 402 comprising a processor implemented network communication interface layer that enables the client terminal 400 to communicate with one or more cloud services servers 300 for the purposes of obtaining cloud services at the client terminal 400. Any and all data communications between client terminal 400 and any cloud services server 300 for the purposes of requesting or receiving cloud services at said client terminal 400 is routed through cloud services server interface layer 402.

In the illustrated embodiment, client terminal 400 comprises a processor 406, a transient memory 408 and a non-transient memory 410. Non-transient memory 410 comprises memory storage that includes a stored second set of software code instructions 412.

Client terminal 400 may optionally include a processor implemented software instruction routing layer 404 configured to implement one or more of the steps of the method of FIG. 5 that are discussed in more detail subsequently, including the steps of (i) receiving for execution, a request for implementing a software code instruction corresponding to an instance of a software application that is under execution, (ii) analyzing the request for implementing the software code instruction, and determining whether the software code instruction is stored on or executable at the cloud services server 300 or at client terminal 400, (iii) routing the request for implementing the software code instruction to one of the processor 406 within client terminal 400 or a cloud services server 300, for execution.

FIG. 5 is a flowchart illustrating a method of selectively routing requests instructions for execution of software code instructions to either one of a client terminal or a cloud services server, in accordance with the teachings of the present invention. It will be understood that in certain embodiments, one or more of the method steps of FIG. 5 may be implemented at one of software instruction routing layers 304, 404.

Step 502 comprises initiating execution of a local software application installed on a client terminal—wherein the local software application is configured to request and receive one or more streamed cloud services from a cloud services server or a cloud services server system. In an embodiment of the invention, the local software application may comprise a web browser application or a dedicated software application configured to request and receive streamed cloud services from the cloud services server or cloud serves server system.

Step 504 comprises initiating a network communication session over a communication network, between the local software application on the client terminal and a cloud services server, for delivery of streaming data from the cloud services server to the client terminal through the local software application.

Step 506 comprises receiving a request f instruction for executing a software code instruction associated with functionality of an instance of a cloud based software application, wherein the instance of the cloud based software application is executed at the cloud services server, and wherein output data from the instance of the cloud based software application is streamed to and rendered on the client terminal through the communication network. The request J instruction may be user initiated, or may be initiated by the local software application, or may be initiated by the instance of the cloud based software application that is being executed at the cloud services server, or may be initiated by the cloud services server. In an embodiment, the request instruction may be received at one of software instruction routing layers 304, 404.

Step 508 comprises selecting based on routing information relevant to the software code instruction, one of the client terminal and the cloud services server for execution of the software code instruction. The routing information relevant to the software code instruction may comprise any one or more of (i) information representing capabilities of the client terminal and/or the cloud services server, (ii) information representing software code instructions stored or configured for execution on the client terminal and or the cloud services, (iii) information representing hardware configurations or hardware systems required or preferred for execution of the software code instruction, and or (iv) information representing one or more rules for routing software code instructions to one or the other of the client terminal and the cloud services server for execution.

Step 510 comprises routing the request/instruction for executing the software code instruction to the selected device (i.e. to the selected client terminal or the selected cloud services server) or to a processor therewithin—for execution.

In an embodiment of the invention more generally described above, the invention comprises a method for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network. The method comprises the steps of (i) initiating network communication between the client terminal and the server, for delivery of streaming data that is output from the instance of the cloud based software application, from the server to the client, terminal, (ii) initiating execution of the instance of the cloud based software application at the server, (iii) receiving a data message identifying a software code instruction for execution, wherein said software code instruction is associated with functionality of the instance of the cloud based software application, (iv) selecting one of the client terminal and the server for execution of the software code instruction, wherein the step of selecting one of the client terminal and the server is based on (a) one or more rules for routing software code instructions to one or the other of the client terminal and the server for execution, and (b) any one or more of information representing capabilities of the client terminal, information representing capabilities of the server, information identifying a storage location of the software code instruction, and information representing hardware configurations or hardware systems required or preferred for execution of the software code instruction, and (v) routing the software code instruction to the selected client terminal or selected server.

In a particular method embodiment, the routed software code instruction is executed at a processor within the selected client terminal or selected server.

In an embodiment of the method, the step of selecting one of the client terminal and the server for execution of the software code instruction is implemented at either the client terminal or the server.

In a further embodiment of the method, (i) the client terminal is configured to implement a first set of software code instructions associated with functionality of the instance of the cloud based software application, (ii) the server is configured to implement a second set of software code instructions associated with functionality of the instance of the cloud based software application, the second set of software code instructions is distinct from (i.e. different or not identical with) the first set of software code instructions, and (iv) the step of selecting one of the client terminal and the server for execution of the software code instruction comprises (a) determining which of the first set of software code instructions and the second set of software code instructions includes the software code instruction identified by the received data message, and (b) responsive to (1) the first set of software code instructions including the software code instruction identified by the received data message, selecting the client terminal for execution of the software code instruction, or (2) the second set of software code instructions including the software code instruction identified by the received data message, selecting the server for execution of the software code instruction.

In another embodiment of the method, one or more of receiving the data message, selecting one of the client terminal and the server for execution of the software code instruction, and routing the software code instruction to the selected client terminal or selected server, are implemented by a processor implemented software instruction routing layer within the client terminal.

In an alternate embodiment of the method, one or more of receiving the data message, selecting one of the client terminal and the server for execution of the software code instruction, and routing the software code instruction to the selected client terminal or selected server, are implemented by a processor implemented software instruction routing layer within the server.

In one embodiment of the method, the cloud based software application is a cloud based gaming software application.

The invention also provides a system for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network. The system comprises at least one processor, and a non-transitory memory.

The processor is configured to implement the steps of (i) initiating network communication between the client terminal and the server, for delivery of streaming data that is output from the instance of the cloud based software application, from the server to the client terminal, (ii) initiating execution of the instance of the cloud based software application a the server, (iii) receiving a data message identifying a software code instruction for execution, wherein said software code instruction is associated with functionality of the instance of the cloud based software application, (iv) selecting one of the client terminal and the server for execution of the software code instruction, wherein the step of selecting one of the client terminal and the server is based on (a) one or more rules for routing software code instructions to one or the other of the client terminal and the server for execution, and (b) any one or more of information representing capabilities of the client terminal, information representing capabilities of the server, information identifying a storage location of the software code instruction, and information representing hardware configurations or hardware systems required or preferred for execution of the software code instruction, and (v) routing the software code instruction to the selected client terminal or selected server.

In a system embodiment, the routed software code instruction is executed at a processor within the selected client, terminal or selected server.

In a further embodiment of the system, the processor is located within either the client terminal or the server.

In a particular embodiment of the system (i) the client terminal is configured to implement a first set of software code instructions associated with functionality of the instance of the cloud based software application, (ii) the server is configured to implement a second set of software code instructions associated with functionality of the instance of the cloud based software application, (iii) the second set of software code instructions is distinct from the first set of software code instructions, and (iv) the step of selecting one of the client terminal and the server for execution of the software code instruction comprises (a) determining which of the first set of software code instructions and the second set of software code instructions includes the software code instruction identified by the received data message, and (b) responsive to (1) the first set of software code instructions including the software code instruction identified by the received data message, selecting the client terminal for execution of the software code instruction, or (2) the second set of software code instructions including the software code instruction identified by the received data message, selecting the server for execution of the software code instruction.

In one embodiment of the system, the cloud based software application is a cloud based gaming software application.

The invention also provides a computer program product for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network. The computer program product comprises a non-transitory computer readable medium having a computer readable program code embodied therein, the computer readable program code comprising instructions for implementing the steps of (i) initiating network communication between the client termini and the server, for delivery of streaming data that is output from the instance of the cloud based software application, from the server to the client terminal, (ii) initiating execution of the instance of the cloud based software application at the server, (iii) receiving a data message identifying a software code instruction for execution, wherein said software code instruction is associated with functionality of the instance of the cloud based software application, (iv) selecting one of the client terminal and the server for execution of the software code instruction, wherein the step of selecting one of the client terminal and the server is based on (a) one or more rules for routing software code instructions to one or the other of the client terminal and the server for execution, and (b) any one or more of information representing capabilities of the client terminal, information representing capabilities of the server, information identifying a storage location of the software code instruction, and information representing hardware configurations or hardware systems required or preferred for execution of the software code instruction, and (v) routing the software code instruction to the selected client terminal or selected server.

In one embodiment of the computer program product, the cloud based software application is a cloud based gaming software application.

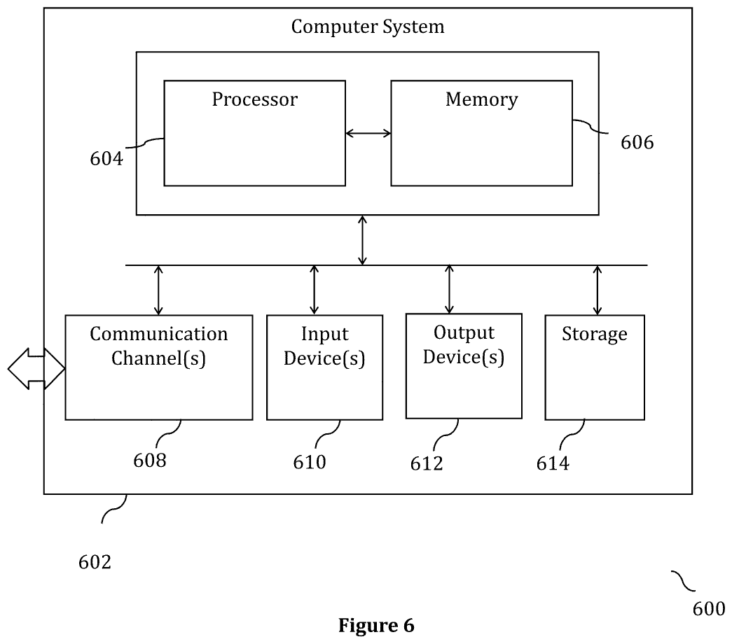

FIG. 6 illustrates an exemplary system 600 for implementing the present invention. The illustrated system 600 comprises computer system 602 which in turn comprises one or more processors 604 and at least one memory 606. Processor 604 is configured to execute program instructions—and may be a real processor or a virtual processor. It will be understood that computer system 602 does not suggest any limitation as to scope of use or functionality of described embodiments. The computer system 602 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 602 in accordance with the present invention may include one or more servers, desktops, laptops, tablets, smart phones, mobile phones, mobile communication devices, tablets, phablets and personal digital assistants. In an embodiment of the present invention, the memory 606 may store software for implementing various embodiments of the present invention. The computer system 602 may have additional components. For example, the computer system 602 may include one or more communication channels 608, one or more input devices 610, one or more output devices 612, and storage 614. An interconnection mechanism (not shown) such as a bus, controller, or network, interconnects the components of the computer system 602. In various embodiments of the present invention, operating system software (not shown) provides an operating environment for various softwares executing in the computer system 602 using a processor 604, and manages different functionalities of the components of the computer system 602.

The communication channel(s) 608 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media,

The input device(s) 610 may include, but is not limited to, a touch screen, a keyboard, mouse, pen, joystick, trackball, a voice device, a scanning device, or any another device that is capable of providing input to the computer system 602. In an embodiment of the present invention, the input device(s) 610 may be a sound card or similar device that accepts audio input in analog or digital form. The output device(s) 612 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 602.

The storage 614 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 602. In various embodiments of the present invention, the storage 614 may contain program instructions for implementing any of the described embodiments.

In an embodiment of the present invention, the computer system 602 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 602. The method described herein is typically implemented as a computer program product, comprising a set of program instructions that is executed by the computer system 602 or any other similar device. The set of program instructions may be a series of computer readable codes stored on a tangible medium, such as a computer readable storage medium (storage 614), for example, diskette, CD-ROM, ROM, flash drives or hard disk, or transmittable to the computer system 602, via a modem or other interface device, over either a tangible medium, including but not limited to optical or analogue communications channel(s) 608. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

The invention accordingly enables selective routing of software instructions between a client device and a cloud services server—wherein the routing decisions are based on one or more of (i) information representing capabilities of the client terminal and or the cloud services server, (ii) information representing software code instructions stored or configured for execution on the client terminal and or the cloud services, (iii) information representing hardware configurations or hardware systems required or preferred for execution of the software code instruction, and (iv) information representing one or more rules for routing software code instructions to one or the other of the client terminal and the cloud services server for execution.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment specifically contemplated, is intended to be practiced in the absence of any element which is not specifically disclosed herein.

We claim:

1. A method for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network, the method comprising the steps of:
initiating network communication between the client terminal and the server, for delivery of streaming data that is output from the instance of the cloud based software application, from the server to the client terminal;
initiating execution of the instance of the cloud based software application at the server;
receiving a data message identifying a software code instruction for execution, wherein said software code instruction is associated with functionality of the instance of the cloud based software application;
selecting one of the client terminal and the server for execution of the software code instruction, wherein the step of selecting one of the client terminal and the server is based on:
one or more rules for routing software code instructions to one or the other of the client terminal and the server for execution; and
any one or more of information representing capabilities of the client terminal, information representing capabilities of the server, information identifying a storage location of the software code instruction, and information representing hardware configurations or hardware systems required or preferred for execution of the software code instruction;
and routing the software code instruction to the selected client terminal or selected server.

2. The method as claimed in claim 1, wherein the routed software code instruction is executed at a processor within the selected client terminal or selected server.

3. The method as claimed in claim 1, wherein the step of selecting one of the client terminal and the server for execution of the software code instruction is implemented at either the client terminal OF the server.

4. The method as claimed in claim 1, wherein:
the client terminal is configured to implement a first set of software code instructions associated with functionality of the instance of the cloud based software application;
the server is configured to implement a second set of software code instructions associated with functionality of the instance of the cloud based software application;
the second set of software code instructions is distinct from the first set of software code instructions; and
the step of selecting one of the client terminal and the server for execution of the software code instruction comprises:
determining which of the first set of software code instructions and the second set of software code instructions includes the software code instruction identified by the received data message; and
responsive to:
the first set of software code instructions including the software code instruction identified by the received data message, selecting the client terminal for execution of the software code instruction; or
the second set of software code instructions including the software code instruction identified by the received data message, selecting the server for execution of the software code instruction.

5. The method as claimed in claim 1, wherein one or more of receiving the data message, selecting one of the client terminal and the server for execution of the software code instruction, and routing the software code instruction to the selected client terminal or selected server, are implemented by a processor implemented software instruction routing layer within the client terminal.

6. The method as claimed in claim 1, wherein one or more of receiving the data message, selecting one of the client terminal and the server for execution of the software code instruction, and routing the software code instruction to the selected client terminal or selected server, are implemented by a processor implemented software instruction routing layer within the server.

7. A system for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network, the system comprising:
at least one processor; and
a non-transitory memory,
wherein the processor is configured or programmed to implement the steps of:
establishing a network communication session between the client terminal and the server, for delivery of streaming data that is output from the instance of the cloud based software application, from the server to the client terminal;
initiating execution of the instance of the cloud based software application at the server;
receiving a data message identifying a software code instruction for execution, wherein said software code instruction is associated with functionality of the instance of the cloud based software application;
selecting one of the client terminal and the server for execution of the software code instruction, wherein the step of selecting one of the client terminal and the server is based on:
one or more rules for routing software code instructions to one or the other of the client terminal and the server for execution; and
any one or more of information representing capabilities of the client terminal, information representing capabilities of the server, information identifying a storage location of the software code instruction, and information representing hardware configurations or hardware systems required or preferred for execution of the software code instruction;
and routing the software code instruction to the selected client terminal or selected server.

8. The system as claimed in claim 7, wherein the routed software code instruction is executed at a processor within the selected client terminal or selected server,

9. The system as claimed in claim 7, wherein the processor is located within either the client terminal or the server,

10. The system as claimed in claim 7, wherein:
the client terminal is configured to implement a first set of software code instructions associated with functionality of the instance of the cloud based software application;
the server is configured to implement a second set of software code instructions associated with functionality of the instance of the cloud based software application;
the second set of software code instructions is distinct from the first set of software code instructions; and
the step of selecting one of the client terminal and the server for execution of the software code instruction comprises:
determining which of the first set of software code instructions and the second set of software code instructions includes the software code instruction identified by the received data message; and
responsive to:
the first set of software code instructions including the software code instruction identified by the received data message, selecting the client terminal for execution of the software code instruction; or
the second set of software code instructions including the software code instruction identified by the received data message, selecting the server for execution of the software code instruction.

12. A computer program product for selective routing of software application instructions corresponding to an instance of a cloud based software application, wherein the instance of the cloud based software application is executed at a server, and wherein output data from the instance of the cloud based software application is streamed to and rendered on a client terminal that is interfaced with the server through a network, the computer program product comprising a non-transitory computer readable medium having a computer readable program code embodied therein, the computer readable program code comprising instructions for implementing the steps of:
initiating network communication between the client terminal and the server, for delivery of streaming data that is output from the instance of the cloud based software application, from the server to the client terminal;
initiating execution of the instance of the cloud based software application at the server;
receiving a data message identifying a software code instruction for execution, wherein said software code instruction is associated with functionality of the instance of the cloud based software application;
selecting one of the client terminal and the server for execution of the software code instruction, wherein the step of selecting one of the client terminal and the server is based on:
one or more rules for routing software code instructions to one or the other of the client terminal and the server for execution; and
any one or more of information representing capabilities of the client terminal, information representing capabilities of the server information identifying a storage location of the software code instruction, and information representing hardware configurations or hardware systems required or preferred for execution of the software code instruction;
and routing the software code instruction to the selected client terminal or selected server.
